(19) United States
(12) Patent Application Publication
(10) Pub. No.: US 2019/0261630 A1
(43) Pub. Date: Aug. 29, 2019

(54) USE OF PYRAZIFLUMID FOR CONTROLLING SCLEROTINIA SPP IN SEED TREATMENT APPLICATIONS

(71) Applicant: Bayer CropScience Aktiengesellschaft, Monheim am Rhein (DE)

(72) Inventor: Haruko SAWADA, Langenfeld (DE)

(21) Appl. No.: 16/343,854

(22) PCT Filed: Oct. 19, 2017
(86) PCT No.: PCT/EP2017/076667

§ 371 Date: Apr. 22, 2019

(30) Foreign Application Priority Data
Oct. 26, 2016 (EP) 16195754.3

(51) Int. Cl. A01N 43/60; A01N 43/42; A01N 43/80; A01N 43/40; A01N 43/653

(52) U.S. Cl. CPC A01N 43/60; A01N 43/42; A01N 43/653; A01N 43/40; A01N 43/80

(57) ABSTRACT

The invention relates to the use of active ingredients such as a succinate dehydrogenase inhibitor such as Pyraziflumid for controlling Sclerotinia spp., to a method for treating plants or plant parts for controlling Sclerotinia spp. and to a method for treating seed for controlling Sclerotinia spp. in the seed and in the plants which grow from the seed, by treating the seed with Pyraziflumid.

The invention relates to the use of a succinate dehydrogenase inhibitor (SDHI, FRAC classification C2) most preferably Pyraziflumid (I)

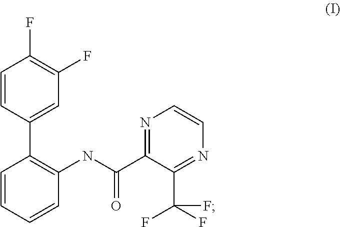 [SMILES: O=C(Nc1ccccc1-c1ccc(F)c(F)c1)c1nccnc1C(F)(F)F]

a compound of formula (II)

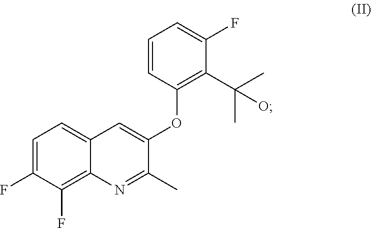

Quinofumelin of formula (III);

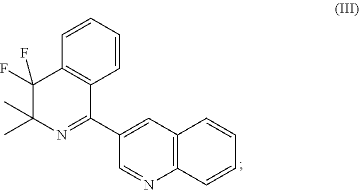 [SMILES: CC1(C)N=C(c2cnc3ccccc3c2)c2ccccc2C1(F)F]

a host plant defence inducer (HPDI, FRAC classification P) such as Isotianil of formula (IV)

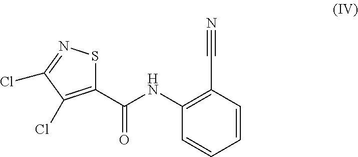 [SMILES: N#Cc1ccccc1NC(=O)c1snc(Cl)c1Cl]

or a host plant defence inducer compound of formula (V)

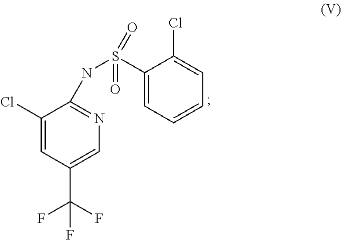 [SMILES: O=S(=O)(Nc1ncc(C(F)(F)F)cc1Cl)c1ccccc1Cl]

or
a C14-Demethylase Inhibitor (DMI, see FRAC classification G1) such as Fluquinconazole of formula (VI)

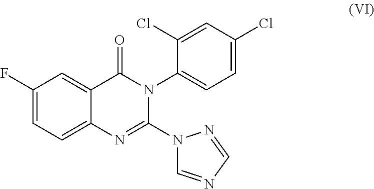 [SMILES: O=c1c2cc(F)ccc2nc(-n2cncn2)n1-c1ccc(Cl)cc1Cl]

or
Mefentrifluconazole of formula (VII)

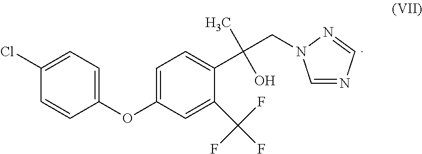 [SMILES: CC(O)(Cn1cncn1)c1ccc(Oc2ccc(Cl)cc2)cc1C(F)(F)F]

for controlling Sclerotinia spp., to a method for treating plants or plant parts for controlling Sclerotinia spp. and to a method for controlling Sclerotinia spp. in seed and in plants which grow from the seed, by treating the seed with a Pyraziflumid or formulations containing the same.

Sclerotinia spp., especially Sclerotinia sclerotiorum, has sclerotia of size 5 to 20 mm and in some cases even larger. With the aid of the sclerotia, the fungi survive in the soil, on affected plant residues or on perennial weeds. If damp conditions persist for several weeks, Sclerotinia sclerotiorum can form the sexual stage: apothecia of 1 to a few cm in size and having ascospores grow from the sclerotia. For the germination of the sclerotia, temperatures must be between 6 and approx. 15° C. Shading of the sclerotia and damp soil are optimal for the germination. The ascospores are finally released and can cause infections on leaves, flowers, fruits and stems. Fallen blossom which gets caught in leaf forks and side shoot branches promotes colonization of the spores and finally the germination thereof. The optimal temperature for the growth of the fungus is approx. 20° C., but it can still grow at 0° C. The sclerotia can survive for up to 10 years in the soil.

A conspicuous sign is yellowing plants, which also rapidly become prematurely ripe. In such plants, pale to brown discolorations are seen over the entire stem on the lower part of the main shoot. The inside of the stem under these discolorations is generally hollow, in which a white, cotton-like mycelium of the fungus proliferates. On this mycelium, small black grains, the sclerotia, are formed. At high air humidity or in the event of persistently wet weather, the mycelium and the sclerotia which appear thereon are also formed on the exterior of the stem. Sclerotinia scleronorum is of great economic significance, in addition to oilseed rape, on the sunflower, on broad beans, soybean, peas, alfalfa and a wide range of different vegetable crops.

Sclerotinia scleronorum is one of the most feared harmful pathogens in soybean cultivation.

There is therefore an urgent need for fungicides which enable sufficient control of Sclerotinia spp, especially of Sclerotinia sclerotiorum, in crop plants, for example oilseed rape, sunflower, broad bean, soybean, pea, alfalfa and a wide range of different vegetable crops. Sclerotinia scleronorum is more preferably to be controlled in soybean.

WO 03/010149 discloses the use of carboxamides fungicides for controlling fungi, for example Sclerotinia scleronorum (page 31 line 1), on transgenic plants, for example soybean, oilseed rape (pages 44-46). According to the invention, all plants, plant parts and/or propagation material are treated. Mixing partners disclosed for the abovementioned carboxamides are a series of fungicides on pages 36-42. However, it is not apparent from the teaching of the publication which specific carboxamides are suitable for preventive treatment to control primary infections in the field caused by ascospores of Sclerotinia spp.

WO 2006/015865 discloses mixtures comprising succinate dehydrogenase inhibitors, for example sedaxane and further active compounds (claims 1-10) against Sclerotinia spp. (page 59 line 7) for treatment of grass, soybean, oilseed rape, sunflower, beans (page 58, line 4). Transgenic plants and the treatment thereof are disclosed on pages 51-52.

EP-A-1 389 614 discloses derivatives of the pyridinilethylbenzamide fungicides, for example fluopyram (claims 1-15), which are utilized against fungi of the Sclerotinia scleronorum genus (page 6 lines 38-39) on, for example, soybean plants (page 6 line 4). However, it is not apparent from the teaching of the publication which specific pyridinilethylbenzamide fungicides are suitable for treatment of Sclerotinia ssp.

WO 2007/1017231 discloses the use of carboxamides fungicides (claims 1-32) for seed treatment against fungi, for example Sclerotinia sclerotiorum, in plants, for example soybean, oilseed rape and sunflower (page 16 lines 27-30). Mixing partners disclosed for the abovementioned carboxamides are a series of fungicides in claim 8. WO 2006/131221 discloses the use of carboxamides fungicides, for example the succinate dehydrogenase inhibitors boscalid and penthiopyrad (claim 4) for control of rust fungi, for example Sclerotinia sclerotiorum, on soybean plants (page 28 line 29 to page 29 line 12). Transgenic plants which can be treated, for example soybean plants, are likewise disclosed (para. 2, page 37, claim 6). Seed treatment is disclosed in para. 2, page 36. Mixing partners disclosed for the abovementioned carboxamides are a series of fungicides on pages 31-32.

WO 2007/118069 discloses a method for treating grass or grass seed against fungi, for example Sclerotinia spp. (Claims 11-15) by means of active carboxamides of the formula I (e.g. isopyrazam). Mixing partners disclosed for the abovementioned carboxamides are a series of fungicides on pages 19-20.

JP 2008/133237 discloses a method for soil treatment in the case of plants, for example beans, against fungi of the Sclerotinia sclerotiorum species by means of pyrazolecarboxamides, for example penthiopyrad.

Pyraziflumid is disclosed in WO2007/072999, and compositions comprising the same are disclosed in JP2014224067. The latter also discloses the general use of Pyraziflumid in seed treatment.

Currently there is no widely accepted standards for seed treatment against Sclerotinia spp. in soybean. Biological control of Sclerotinia sclerotiorum is known, e.g. with soil treatment of Coniothyrium minitans (WO96/21358) or seed treatment of Trichoderma asperellum (http://www.biocontrole.com.br/?area=produtos&id=33), however their mechanism of action is not preventing plants directly against primary infection of ascospore in the field.

Further, it is known from e.g. WO2010/139410 that e.g fluopyram can be used to treat plants against Sclerotinia spp., also as a seed treatment.

It would therefore be of particular interest to provide an alternative solution against Sclerotinia spp. by way of seed treatment.

It has now been found that a succinate dehydrogenase inhibitor (SDHI, FRAC classification C2) most preferably Pyraziflumid (I)

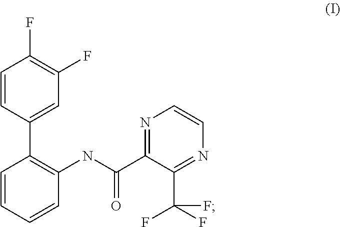 [SMILES: O=C(Nc1ccccc1-c1ccc(F)c(F)c1)c1nccnc1C(F)(F)F]

a compound of formula (II)

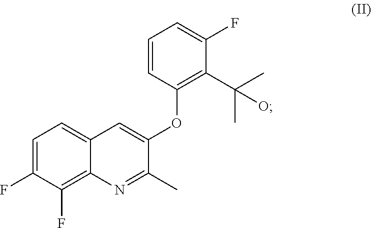

Quinofumelin of formula (III);

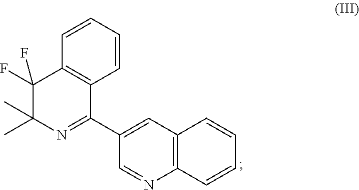 [SMILES: CC1(C)N=C(c2cnc3ccccc3c2)c2ccccc2C1(F)F]

a plant host defence inducer (FRAC classification P) such as Isotianil of formula (IV)

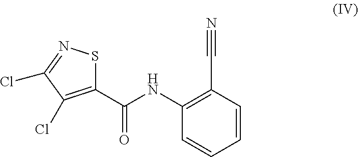 [SMILES: N#Cc1ccccc1NC(=O)c1snc(Cl)c1Cl]

or A plant host defence inducer compound of formula (V)

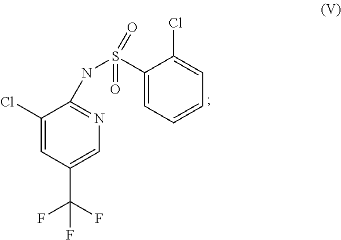 [SMILES: O=S(=O)(Nc1ncc(C(F)(F)F)cc1Cl)c1ccccc1Cl]

or
a C14-Demethylase Inhibitor (DMI, see FRAC classification G1) such as Fluquinconazole of formula (VI)

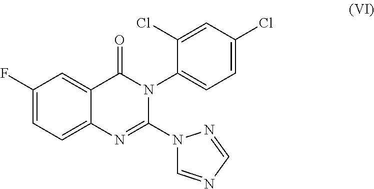 [SMILES: O=c1c2cc(F)ccc2nc(-n2cncn2)n1-c1ccc(Cl)cc1Cl]

or
Mefentrifluconazole of formula (VII)

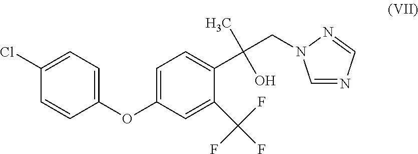 [SMILES: CC(O)(Cn1cncn1)c1ccc(Oc2ccc(Cl)cc2)cc1C(F)(F)F]

Are suitable for control of Sclerotinia spp, especially of Sclerotinia sclerotiorum, very particular as a seed treatment in crop plants, for example oilseed rape, sunflower, broad bean, soybean, pea, alfalfa and vegetable crops, especially in soybean.

Pyraziflumid

It has now been found that, surprisingly, Pyraziflumid, a succinate dehydrogenase inhibitor (SDHI), is outstandingly suitable for control of Sclerotinia spp, especially of Sclerotinia sclerotiorum, very particular as a seed treatment in crop plants, for example oilseed rape, sunflower, broad bean, soybean, pea, alfalfa and vegetable crops, especially in soybean. Although Pyraziflumid is the most preferred SDHI, also further SDHI may be suitable for control of Sclerotinia spp, especially of Sclerotinia sclerotiorum, very particular as a seed treatment in crop plants, for example oilseed rape, sunflower, broad bean, soybean, pea, alfalfa and vegetable crops, especially in soybean.

However, the aforementioned plants merely constitute examples. In principle, it is possible to treat any plant affected by Sclerotinia spp. or preferably protect plants grown from seeds treated with

Pyraziflumid.

The use of Pyraziflumid, for control of Sclerotinia sclerotiorum preferably in soybean (soybean, Glycine Max.) in particular by seed treatment, has been found to be particularly advantageous.

In an alternative embodiment of the invention, combinations comprising a succinate dehydrogenase inhibitor (SDHI), most preferably Pyraziflumid, and at least one additional fungicide for example and preferably selected from prothioconazole, azoxy strobin, picoxy strobin, pyraclostrobin, iprodione, fludioxonyl, propiconazole, epoxiconazole, cyproconazole, tebuconazole, procymidone fluazinam, carbendazim, metominostrobin can be used for control of Sclerotinia sclerotiorum in soybean.

In another alternative embodiment of the invention, combinations comprising a succinate dehydrogenase inhibitor (SDHI), most preferably Pyraziflumid, and at least one insecticide for example and preferably selected from imidacloprid, clothianidin, thiacloprid, thiamethoxam, spinosad, spinoteram, chloranthraniliprole, flubendiamide, cyantraniloprole, flupyradifuron, sulfoxaflor, avermectin, thiodicarb, methiocarb, can be used for the treatment of seed according to the invention. These treatments preferably also comprise at least one additional fungicide.

In a further preferred embodiment, a combination according to the invention comprises a succinate dehydrogenase inhibitor (SDHI), most preferably Pyraziflumid, and at least one insecticide for example and preferably selected from imidacloprid, clothianidin, thiacloprid, thiamethoxm, spinosad, spinoteram, chloranthraniliprole, flubendiamide, cyantraniliprole, flupyradifuron, sulfoxaflor, avermectin, thiodicarb, methiocarb.

In a further preferred embodiment, a combination according to the invention comprises a succinate dehydrogenase inhibitor (SDHI), most preferably Pyraziflumid, and at least one fungicide for example and preferably selected from prothioconazole, azoxystrobin, picoxystrobin, pyraclostrobin, iprodione, fludioxonyl, propiconazole, epoxiconazole, cyproconazole, tebuconazole, procymidone fluazinam, carbendazim, Metominostrobin.

In a further preferred embodiment, a combination according to the invention comprises a succinate dehydrogenase inhibitor (SDHI, most preferably Pyraziflumid, and at least one insecticide for example and preferably selected from imidacloprid, clothianidin, thiacloprid, thiamethoxm, spinosad, spinoteram, chloranthraniliprole, flubendiamide, cyantraniliprole, flupyradifuron, sulfoxaflor, avermectin, thiodicarb, methiocarb and at least one fungicide for example and preferably selected from prothioconazole, azoxystrobin, picoxystrobin, pyraclostrobin, iprodione, fludioxonyl, propiconazole, epoxiconazole, cyproconazole, tebuconazole, procymidone fluazinam, carbendazim, Metominostrobin.

In a further preferred embodiment, a combination according to the invention comprises a succinate dehydrogenase inhibitor (SDHI), most preferably Pyraziflumid, and a fungicide for example and preferably selected from prothioconazole, azoxystrobin, picoxystrobin, pyraclostrobin, iprodione, fludioxonyl, propiconazole, epoxiconazole, cyproconazole, tebuconazole, procymidone fluazinam, carbendazim, Metominostrobin.

In a further preferred embodiment, a combination according to the invention comprises a succinate dehydrogenase inhibitor (SDHI), most preferably Pyraziflumid, and an insecticide for example and preferably selected from imidacloprid, clothianidin, thiacloprid, thiamethoxm, spinosad, spinoteram, chloranthraniliprole, flubendiamide, cyantraniliprole, flupyradifuron, sulfoxaflor, avermectin, thiodicarb, methiocarb and a fungicide for example and preferably selected from prothioconazole, azoxystrobin, picoxystrobin, pyraclostrobin, iprodione, fludioxonyl, propiconazole, epoxiconazole, cyproconazole, tebuconazole, procymidone fluazinam, carbendazim, metominostrobin.

The present invention accordingly provides for the use of a succinate dehydrogenase inhibitor (SDHI), most preferably Pyraziflumid, for control of Sclerotinia sclerotiorum as a seed treatment with excellent phytocompatibility.

The most preferred compound in the methods and uses according to the invention is Pyraziflumid.

Surprisingly, a succinate dehydrogenase inhibitor (SDHI), most preferably Pyraziflumid, is particularly potent against Sclerotinia spp. as a seed treatment, preferably to control Sclerotinia spp. in soybean.

In the context of the present invention, “control of Sclerotinia spp.” means a significant reduction in primary infection by Sclerotinia spp., compared with the untreated plant, preferably a significant reduction (by a value of between 40-79% compared to an untreated control plant), compared with the untreated plant (100%); more preferably, the primary infection by Sclerotinia spp. is entirely suppressed (by a value of between 80-100% compared to an untreated control plant). The control is for protection of plants which have not yet been infected.

In one preferred embodiment, the above reduction in primary infection by Sclerotinia spp., compared with the untreated plant is of at least 40%, more preferably at least 60%, even more preferably at least 70%. Preferably, the reduction is achieved by Pyraziflumid.

In another preferred embodiment, this reduction of at least 40%, more preferably at least 60%, even more preferably at least 70% is achieved by using at most 200 g a.i./100 kg seed, such as at most 150 g a.i./100 kg seed or such as at most 140 g a.i./100 kg seed. Preferably the a.i. is Pyraziflumid.

In another preferred embodiment, this reduction of at least 40%, more preferably at least 60%, even more preferably at least 70% is achieved by using at most 200 g a.i./100 kg soybeansoybean seed, such as at most 150 g a.i./100 kg soybean seed or such as at most 140 g a.i./100 kg soybean seed. Preferably the a.i. is Pyraziflumid.

In yet another preferred embodiment, this reduction of at least 40%, more preferably at least 60%, even more preferably at least 70% is achieved by using at most 200 g Pyraziflumid/100 kg soybean seed, such as at most 150 g Pyraziflumid/100 kg soybean seed or such as at most 140 g Pyraziflumid/100 kg soybean seed.

More particularly, the inventive use exhibits the advantages described on plants and plant parts or seed in spray application, in seed treatment, in drip and drench applications, in-furrow applications, on-seed application and overall soil incorporation, chemigation, i.e. by addition of the active ingredients to the irrigation water, and in hydroponic/mineral systems.

Combinations of a succinate dehydrogenase inhibitor (SDHI), most preferably Pyraziflumid, with substances including insecticides, fungicides and bactericides, fertilizers, growth regulators, can likewise find use in the control of plant diseases in the context of the present invention. The combined use of a succinate dehydrogenase inhibitor (SDHI), most preferably Pyraziflumid, with genetically modified cultivars, especially of transgenic soybean cultivars, is additionally likewise possible.

In the context of the present invention, a plant is preferably understood to mean a plant at or after the stage of leaf development (at or after BBCH stage 10 according to the BBCH monograph from the German Federal Biological Research Centre for Agriculture and Forestry, 2nd edition, 2001). In the context of the present invention, the term “plant” is also understood to mean seed or seedlings.

### Compound of Formula (II)

It has now been found that, surprisingly, a compound of formula (II)

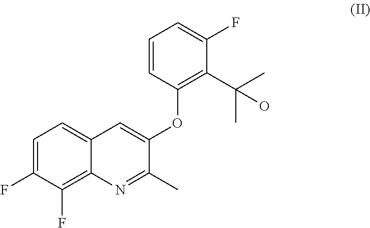 [SMILES: Cc1nc2c(F)c(F)ccc2cc1Oc1cccc(F)c1C(C)(C)O]

is suitable for control of Sclerotinia spp, especially of Sclerotinia sclerotiorum, very particular as a seed treatment in crop plants, for example oilseed rape, sunflower, broad bean, soybean, pea, alfalfa and vegetable crops, especially in soybean.

However, the aforementioned plants merely constitute examples. In principle, it is possible to treat any plant affected by Sclerotinia spp. or preferably protect plants grown from seeds treated with a compound of formula (II).

The use of a compound of formula (II), for control of Sclerotinia sclerotiorum preferably in soybean (soybean, Glycine Max.) in particular by seed treatment, has been found to be particularly advantageous.

In an alternative embodiment of the invention, combinations comprising a compound of formula (II) and at least one additional fungicide for example and preferably selected from prothioconazole, azoxystrobin, picoxystrobin, pyraclostrobin, iprodione, fludioxonyl, propiconazole, epoxiconazole, cyproconazole, tebuconazole, procymidone fluazinam, carbendazim, metominostrobin can be used for control of Sclerotinia sclerotiorum in soybean.

In another alternative embodiment of the invention, combinations comprising a compound of formula (II) and at least one insecticide for example and preferably selected from imidacloprid, clothianidin, thiacloprid, thiamethoxam, spinosad, spinoteram, chloranthraniliprole, flubendiamide, cyantraniloprole, flupyradifuron, sulfoxaflor, avermectin, thiodicarb, methiocarb, can be used for the treatment of seed according to the invention. These treatments preferably also comprise at least one additional fungicide.

In a further preferred embodiment, a combination according to the invention comprises a compound of formula (II) and at least one insecticide for example and preferably selected from imidacloprid, clothianidin, thiacloprid, thiamethoxm, spinosad, spinoteram, chloranthraniliprole, flubendiamide, cyantraniliprole, flupyradifuron, sulfoxaflor, avermectin, thiodicarb, methiocarb.

In a further preferred embodiment, a combination according to the invention comprises a compound of formula (II) and at least one fungicide for example and preferably selected from prothioconazole, azoxystrobin, picoxystrobin, pyraclostrobin, iprodione, fludioxonyl, propiconazole, epoxiconazole, cyproconazole, tebuconazole, procymidone fluazinam, carbendazim, Metominostrobin.

In a further preferred embodiment, a combination according to the invention comprises a compound of formula (II) and at least one insecticide for example and preferably selected from imidacloprid, clothianidin, thiacloprid, thiamethoxm, spinosad, spinoteram, chloranthraniliprole, flubendiamide, cyantraniliprole, flupyradifuron, sulfoxaflor, avermectin, thiodicarb, methiocarb and at least one fungicide for example and preferably selected from prothioconazole, azoxystrobin, picoxystrobin, pyraclostrobin, iprodione, fludioxonyl, propiconazole, epoxiconazole, cyproconazole, tebuconazole, procymidone fluazinam, carbendazim, Metominostrobin.

In a further preferred embodiment, a combination according to the invention comprises a compound of formula (II) and a fungicide for example and preferably selected from prothioconazole, azoxystrobin, picoxystrobin, pyraclostrobin, iprodione, fludioxonyl, propiconazole, epoxiconazole, cyproconazole, tebuconazole, procymidone fluazinam, carbendazim, Metominostrobin.

In a further preferred embodiment, a combination according to the invention comprises a compound of formula (II) and an insecticide for example and preferably selected from imidacloprid, clothianidin, thiacloprid, thiamethoxm, spinosad, spinoteram, chloranthraniliprole, flubendiamide, cyantraniliprole, flupyradifuron, sulfoxaflor, avermectin, thiodicarb, methiocarb and a fungicide for example and preferably selected from prothioconazole, azoxystrobin, picoxystrobin, pyraclostrobin, iprodione, fludioxonyl, propiconazole, epoxiconazole, cyproconazole, tebuconazole, procymidone fluazinam, carbendazim, metominostrobin.

The present invention accordingly provides for the use of a compound of formula (II) for control of Sclerotinia sclerotiorum as a seed treatment with excellent phytocompatibility.

Surprisingly, a compound of formula (II) is particularly potent against Sclerotinia spp. as a seed treatment, preferably to control Sclerotinia spp. in soybean.

In the context of the present invention, “control of Sclerotinia spp.” means a significant reduction in primary infection by Sclerotinia spp., compared with the untreated plant, preferably a significant reduction (by a value of between 40-79% compared to an untreated control plant), compared with the untreated plant (100%); more preferably, the primary infection by Sclerotinia spp. is entirely suppressed (by a value of between 80-100% compared to an untreated control plant). The control is for protection of plants which have not yet been infected.

In one preferred embodiment, the above reduction in primary infection by Sclerotinia spp., compared with the untreated plant is of at least 40%, more preferably at least 60%, even more preferably at least 70%. Preferably, the reduction is achieved by a compound of formula (II).

In another preferred embodiment, this reduction of at least 40%, more preferably at least 60%, even more preferably at least 70% is achieved by using at most 200 g a.i./100 kg seed, such as at most 150 g a.i./100 kg seed or such as at most 140 g a.i./100 kg seed. Preferably the a.i. is a compound of formula (II).

In another preferred embodiment, this reduction of at least 40%, more preferably at least 60%, even more preferably at least 70% is achieved by using at most 200 g a.i./100 kg soybeansoybean seed, such as at most 150 g a.i./100 kg soybean seed or such as at most 140 g a.i./100 kg soybean seed. Preferably the a.i. is a compound of formula (II).

In yet another preferred embodiment, this reduction of at least 40%, more preferably at least 60%, even more preferably at least 70% is achieved by using at most 200 g of a compound of formula (II)/100 kg soybean seed, such as at most 150 g of a compound of formula (II)/100 kg soybean seed or such as at most 140 g of a compound of formula (II)/100 kg soybean seed.

More particularly, the inventive use exhibits the advantages described on plants and plant parts or seed in spray application, in seed treatment, in drip and drench applications, in-furrow applications, on-seed application and overall soil incorporation, chemigation, i.e. by addition of the active ingredients to the irrigation water, and in hydroponic/mineral systems.

Combinations of a compound of formula (II) with substances including insecticides, fungicides and bactericides, fertilizers, growth regulators, can likewise find use in the control of plant diseases in the context of the present invention. The combined use of a compound of formula (II), with genetically modified cultivars, especially of transgenic soybean cultivars, is additionally likewise possible.

In the context of the present invention, a plant is preferably understood to mean a plant at or after the stage of leaf development (at or after BBCH stage 10 according to the BBCH monograph from the German Federal Biological Research Centre for Agriculture and Forestry, 2nd edition, 2001). In the context of the present invention, the term “plant” is also understood to mean seed or seedlings.

Quinofumelin

It has now been found that, surprisingly, Quinofumelin of formula (III);

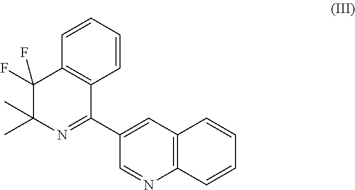 [SMILES: CC1(C)N=C(c2cnc3ccccc3c2)c2ccccc2C1(F)F]

is suitable for control of Sclerotinia spp, especially of Sclerotinia sclerotiorum, very particular as a seed treatment in crop plants, for example oilseed rape, sunflower, broad bean, soybean, pea, alfalfa and vegetable crops, especially in soybean.

However, the aforementioned plants merely constitute examples. In principle, it is possible to treat any plant affected by Sclerotinia spp. or preferably protect plants grown from seeds treated with Quinofumelin.

The use of Quinofumelin, for control of Sclerotinia sclerotiorum preferably in soybean (soybean, Glycine Max.) in particular by seed treatment, has been found to be particularly advantageous.

In an alternative embodiment of the invention, combinations comprising Quinofumelin and at least one additional fungicide for example and preferably selected from prothioconazole, azoxystrobin, picoxystrobin, pyraclostrobin, iprodione, fludioxonyl, propiconazole, epoxiconazole, cyproconazole, tebuconazole, procymidone fluazinam, carbendazim, metominostrobin can be used for control of Sclerotinia sclerotiorum in soybean.

In another alternative embodiment of the invention, combinations comprising Quinofumelin and at least one insecticide for example and preferably selected from imidacloprid, clothianidin, thiacloprid, thiamethoxam, spinosad, spinoteram, chloranthraniliprole, flubendiamide, cyantraniloprole, flupyradifuron, sulfoxaflor, avermectin, thiodicarb, methiocarb, can be used for the treatment of seed according to the invention. These treatments preferably also comprise at least one additional fungicide.

In a further preferred embodiment, a combination according to the invention comprises Quinofumelin and at least one insecticide for example and preferably selected from imidacloprid, clothianidin, thiacloprid, thiamethoxm, spinosad, spinoteram, chloranthraniliprole, flubendiamide, cyantraniliprole, flupyradifuron, sulfoxaflor, avermectin, thiodicarb, methiocarb.

In a further preferred embodiment, a combination according to the invention comprises Quinofumelin and at least one fungicide for example and preferably selected from prothioconazole, azoxystrobin, picoxystrobin, pyraclostrobin, iprodione, fludioxonyl, propiconazole, epoxiconazole, cyproconazole, tebuconazole, procymidone fluazinam, carbendazim, Metominostrobin.

In a further preferred embodiment, a combination according to the invention comprises Quinofumelin and at least one insecticide for example and preferably selected from imidacloprid, clothianidin, thiacloprid, thiamethoxm, spinosad, spinoteram, chloranthraniliprole, flubendiamide, cyantraniliprole, flupyradifuron, sulfoxaflor, avermectin, thiodicarb, methiocarb and at least one fungicide for example and preferably selected from prothioconazole, azoxystrobin, picoxystrobin, pyraclostrobin, iprodione, fludioxonyl, propiconazole, epoxiconazole, cyproconazole, tebuconazole, procymidone fluazinam, carbendazim, Metominostrobin.

In a further preferred embodiment, a combination according to the invention comprises Quinofumelin and a fungicide for example and preferably selected from prothioconazole, azoxystrobin, picoxystrobin, pyraclostrobin, iprodione, fludioxonyl, propiconazole, epoxiconazole, cyproconazole, tebuconazole, procymidone fluazinam, carbendazim, Metominostrobin.

In a further preferred embodiment, a combination according to the invention comprises Quinofumelin and an insecticide for example and preferably selected from imidacloprid, clothianidin, thiacloprid, thiamethoxm, spinosad, spinoteram, chloranthraniliprole, flubendiamide, cyantraniliprole, flupyradifuron, sulfoxaflor, avermectin, thiodicarb, methiocarb and a fungicide for example and preferably selected from prothioconazole, azoxystrobin, picoxystrobin, pyraclostrobin, iprodione, fludioxonyl, propiconazole, epoxiconazole, cyproconazole, tebuconazole, procymidone fluazinam, carbendazim, metominostrobin.

The present invention accordingly provides for the use of Quinofumelin for control of Sclerotinia sclerotiorum as a seed treatment with excellent phytocompatibility.

Surprisingly, Quinofumelin is particularly potent against Sclerotinia spp. as a seed treatment, preferably to control Sclerotinia spp. in soybean.

In the context of the present invention, “control of Sclerotinia spp.” means a significant reduction in primary infection by Sclerotinia spp., compared with the untreated plant, preferably a significant reduction (by a value of between 40-79% compared to an untreated control plant), compared with the untreated plant (100%); more preferably, the primary infection by Sclerotinia spp. is entirely suppressed (by a value of between 80-100% compared to an untreated control plant). The control is for protection of plants which have not yet been infected.

In one preferred embodiment, the above reduction in primary infection by Sclerotinia spp., compared with the untreated plant is of at least 40%, more preferably at least 60%, even more preferably at least 70%. Preferably, the reduction is achieved by Quinofumelin.

In another preferred embodiment, this reduction of at least 40%, more preferably at least 60%, even more preferably at least 70% is achieved by using at most 200 g a.i./100 kg seed, such as at most 150 g a.i./100 kg seed or such as at most 140 g a.i./100 kg seed. Preferably the a.i. is Quinofumelin.

In another preferred embodiment, this reduction of at least 40%, more preferably at least 60%, even more preferably at least 70% is achieved by using at most 200 g a.i./100 kg soybean seed, such as at most 150 g a.i./100 kg soybean seed or such as at most 140 g a.i./100 kg soybean seed. Preferably the a.i. is Quinofumelin.

In yet another preferred embodiment, this reduction of at least 40%, more preferably at least 60%, even more preferably at least 70% is achieved by using at most 200 g Quinofumelin/100 kg soybean (soybean) seed, such as at most 150 g Quinofumelin/100 kg soybean seed or such as at most 140 g Pyraziflumid/100 kg soybean seed.

More particularly, the inventive use exhibits the advantages described on plants and plant parts or seed in spray application, in seed treatment, in drip and drench applications, in-furrow applications, on-seed application and overall soil incorporation, chemigation, i.e. by addition of the active ingredients to the irrigation water, and in hydroponic/mineral systems.

Combinations of a succinate dehydrogenase inhibitor (SDHI), most preferably Pyraziflumid, with substances including insecticides, fungicides and bactericides, fertilizers, growth regulators, can likewise find use in the control of plant diseases in the context of the present invention. The combined use of Quinofumelin with genetically modified cultivars, especially of transgenic soybean cultivars, is additionally likewise possible.

In the context of the present invention, a plant is preferably understood to mean a plant at or after the stage of leaf development (at or after BBCH stage 10 according to the BBCH monograph from the German Federal Biological Research Centre for Agriculture and Forestry, 2nd edition, 2001). In the context of the present invention, the term “plant” is also understood to mean seed or seedlings.

Host Plant Defence Inducers (HPDI)

It has now been found that, surprisingly, HPDI (FRAC classification P) such as Isotianil of formula (IV)

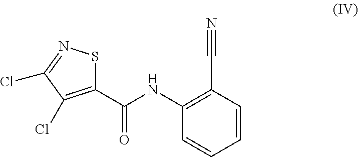 [SMILES: N#Cc1ccccc1NC(=O)c1snc(Cl)c1Cl]

or a plant host defence inducer compound of formula (V)

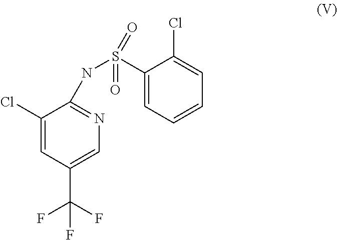 [SMILES: O=S(=O)(Nc1ncc(C(F)(F)F)cc1Cl)c1ccccc1Cl]

is suitable for control of Sclerotinia spp, especially of Sclerotinia sclerotiorum, very particular as a seed treatment in crop plants, for example oilseed rape, sunflower, broad bean, soybean, pea, alfalfa and vegetable crops, especially in soybean.

However, the aforementioned plants merely constitute examples. In principle, it is possible to treat any plant affected by Sclerotinia spp. or preferably protect plants grown from seeds treated with a HPDI preferably Isotianil or a plant host defence inducer compound of formula (V).

The use of a HPDI preferably Isotianil or a plant host defence inducer compound of formula (V), for control of Sclerotinia sclerotiorum preferably in soybean (soybean, Glycine Max.) in particular by seed treatment, has been found to be particularly advantageous.

In an alternative embodiment of the invention, combinations comprising a HPDI preferably Isotianil or a plant host defence inducer compound of formula (V), and at least one additional fungicide for example and preferably selected from prothioconazole, azoxystrobin, picoxystrobin, pyraclostrobin, iprodione, fludioxonyl, propiconazole, epoxiconazole, cyproconazole, tebuconazole, procymidone fluazinam, carbendazim, metominostrobin can be used for control of Sclerotinia sclerotiorum in soybean.

In another alternative embodiment of the invention, combinations comprising a HPDI preferably Isotianil or a plant host defence inducer compound of formula (V), and at least one insecticide for example and preferably selected from imidacloprid, clothianidin, thiacloprid, thiamethoxam, spinosad, spinoteram, chloranthraniliprole, flubendiamide, cyantraniloprole, flupyradifuron, sulfoxaflor, avermectin, thiodicarb, methiocarb, can be used for the treatment of seed according to the invention.

These treatments preferably also comprise at least one additional fungicide.

In a further preferred embodiment, a combination according to the invention comprises a HPDI preferably Isotianil or a plant host defence inducer compound of formula (V), and at least one insecticide for example and preferably selected from imidacloprid, clothianidin, thiacloprid, thiamethoxm, spinosad, spinoteram, chloranthraniliprole, flubendiamide, cyantraniliprole, flupyradifuron, sulfoxaflor, avermectin, thiodicarb, methiocarb.

In a further preferred embodiment, a combination according to the invention comprises a HPDI preferably Isotianil or a plant host defence inducer compound of formula (V), and at least one fungicide for example and preferably selected from prothioconazole, azoxystrobin, picoxystrobin, pyraclostrobin, iprodione, fludioxonyl, propiconazole, epoxiconazole, cyproconazole, tebuconazole, procymidone fluazinam, carbendazim, Metominostrobin.

In a further preferred embodiment, a combination according to the invention comprises a HPDI preferably Isotianil or a plant host defence inducer compound of formula (V), and at least one insecticide for example and preferably selected from imidacloprid, clothianidin, thiacloprid, thiamethoxm, spinosad, spinoteram, chloranthraniliprole, flubendiamide, cyantraniliprole, flupyradifuron, sulfoxaflor, avermectin, thiodicarb, methiocarb and at least one fungicide for example and preferably selected from prothioconazole, azoxystrobin, picoxystrobin, pyraclostrobin, iprodione, fludioxonyl, propiconazole, epoxiconazole, cyproconazole, tebuconazole, procymidone fluazinam, carbendazim, Metominostrobin.

In a further preferred embodiment, a combination according to the invention comprises a HPDI preferably Isotianil or a plant host defence inducer compound of formula (V), and a fungicide for example and preferably selected from prothioconazole, azoxystrobin, picoxystrobin, pyraclostrobin, iprodione, fludioxonyl, propiconazole, epoxiconazole, cyproconazole, tebuconazole, procymidone fluazinam, carbendazim, Metominostrobin.

In a further preferred embodiment, a combination according to the invention comprises a HPDI preferably Isotianil or a plant host defence inducer compound of formula (V), and an insecticide for example and preferably selected from imidacloprid, clothianidin, thiacloprid, thiamethoxm, spinosad, spinoteram, chloranthraniliprole, flubendiamide, cyantraniliprole, flupyradifuron, sulfoxaflor, avermectin, thiodicarb, methiocarb and a fungicide for example and preferably selected from prothioconazole, azoxystrobin, picoxystrobin, pyraclostrobin, iprodione, fludioxonyl, propiconazole, epoxiconazole, cyproconazole, tebuconazole, procymidone fluazinam, carbendazim, metominostrobin.

The present invention accordingly provides for the use of a HPDI preferably Isotianil or a plant host defence inducer compound of formula (V), for control of Sclerotinia sclerotiorum as a seed treatment with excellent phytocompatibility.

Surprisingly, a HPDI preferably Isotianil or a plant host defence inducer compound of formula (V), is particularly potent against Sclerotinia spp. as a seed treatment, preferably to control Sclerotinia spp. in soybean.

In the context of the present invention, “control of Sclerotinia spp.” means a significant reduction in primary infection by Sclerotinia spp., compared with the untreated plant, preferably a significant reduction (by a value of between 40-79% compared to an untreated control plant), compared with the untreated plant (100%); more preferably, the primary infection by Sclerotinia spp. is entirely suppressed (by a value of between 80-100% compared to an untreated control plant). The control is for protection of plants which have not yet been infected.

In one preferred embodiment, the above reduction in primary infection by Sclerotinia spp., compared with the untreated plant is of at least 40%, more preferably at least 60%, even more preferably at least 70%. Preferably, the reduction is achieved by a HPDI preferably Isotianil or a plant host defence inducer compound of formula (V).

In another preferred embodiment, this reduction of at least 40%, more preferably at least 60%, even more preferably at least 70% is achieved by using at most 200 g a.i./100 kg seed, such as at most 150 g a.i./100 kg seed or such as at most 140 g a.i./100 kg seed. Preferably the a.i. is a HPDI preferably Isotianil or a plant host defence inducer compound of formula (V).

In another preferred embodiment, this reduction of at least 40%, more preferably at least 60%, even more preferably at least 70% is achieved by using at most 200 g a.i./100 kg soybeansoybean seed, such as at most 150 g a.i./100 kg soybean seed or such as at most 140 g a.i./100 kg soybean seed. Preferably the a.i. is a HPDI preferably Isotianil or a plant host defence inducer compound of formula (V).

In yet another preferred embodiment, this reduction of at least 40%, more preferably at least 60%, even more preferably at least 70% is achieved by using at most 200 g of a HPDI preferably Isotianil or a plant host defence inducer compound of formula (V)/100 kg soybean seed, such as at most 150 g of a HPDI preferably Isotianil or a plant host defence inducer compound of formula (V)/100 kg soybean seed or such as at most 140 g of a HPDI preferably Isotianil or a plant host defence inducer compound of formula (V)/100 kg soybean seed.

More particularly, the inventive use exhibits the advantages described on plants and plant parts or seed in spray application, in seed treatment, in drip and drench applications, in-furrow applications, on-seed application and overall soil incorporation, chemigation, i.e. by addition of the active ingredients to the irrigation water, and in hydroponic/mineral systems.

Combinations of a HPDI, preferably Isotianil or a plant host defence inducer compound of formula (V), with substances including insecticides, fungicides and bactericides, fertilizers, growth regulators, can likewise find use in the control of plant diseases in the context of the present invention. The combined use of a HPDI preferably Isotianil or a plant host defence inducer compound of formula (V), with genetically modified cultivars, especially of transgenic soybean cultivars, is additionally likewise possible.

In the context of the present invention, a plant is preferably understood to mean a plant at or after the stage of leaf development (at or after BBCH stage 10 according to the BBCH monograph from the German Federal Biological Research Centre for Agriculture and Forestry, 2nd edition, 2001). In the context of the present invention, the term “plant” is also understood to mean seed or seedlings.

DMI

It has now been found that, surprisingly, a C14-Demethylase Inhibitor (DMI, see FRAC classification G1) such as Fluquinconazole of formula (VI)

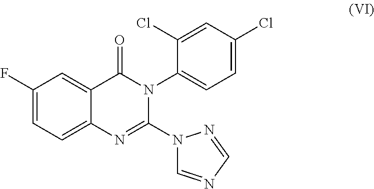 [SMILES: O=c1c2cc(F)ccc2nc(-n2cncn2)n1-c1ccc(Cl)cc1Cl]

or Mefentrifluconazole of formula (VII)

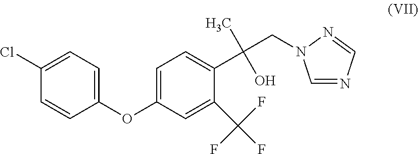 [SMILES: CC(O)(Cn1cncn1)c1ccc(Oc2ccc(Cl)cc2)cc1C(F)(F)F]

is suitable for control of Sclerotinia spp, especially of Sclerotinia sclerotiorum, very particular as a seed treatment in crop plants, for example oilseed rape, sunflower, broad bean, soybean, pea, alfalfa and vegetable crops, especially in soybean.

However, the aforementioned plants merely constitute examples. In principle, it is possible to treat any plant affected by Sclerotinia spp. or preferably protect plants grown from seeds treated with a DMI, preferably Fluquinconazole or Mefentrifluconazole.

The use of a DMI, preferably Fluquinconazole or Mefentrifluconazole, for control of Sclerotinia sclerotiorum preferably in soybean (soybean, Glycine Max.) in particular by seed treatment, has been found to be particularly advantageous.

In an alternative embodiment of the invention, combinations comprising a DMI, preferably Fluquinconazole or Mefentrifluconazole, and at least one additional fungicide for example and preferably selected from prothioconazole, azoxystrobin, picoxystrobin, pyraclostrobin, iprodione, fludioxonyl, propiconazole, epoxiconazole, cyproconazole, tebuconazole, procymidone fluazinam, carbendazim, metominostrobin can be used for control of Sclerotinia sclerotiorum in soybean.

In another alternative embodiment of the invention, combinations comprising a DMI, preferably Fluquinconazole or Mefentrifluconazole, and at least one insecticide for example and preferably selected from imidacloprid, clothianidin, thiacloprid, thiamethoxam, spinosad, spinoteram, chloranthraniliprole, flubendiamide, cyantraniloprole, flupyradifuron, sulfoxaflor, avermectin, thiodicarb, methiocarb, can be used for the treatment of seed according to the invention. These treatments preferably also comprise at least one additional fungicide.

In a further preferred embodiment, a combination according to the invention comprises a DMI, preferably Fluquinconazole or Mefentrifluconazole, and at least one insecticide for example and preferably selected from imidacloprid, clothianidin, thiacloprid, thiamethoxm, spinosad, spinoteram, chloranthraniliprole, flubendiamide, cyantraniliprole, flupyradifuron, sulfoxaflor, avermectin, thiodicarb, methiocarb.

In a further preferred embodiment, a combination according to the invention comprises a DMI, preferably Fluquinconazole or Mefentrifluconazole, and at least one fungicide for example and preferably selected from prothioconazole, azoxystrobin, picoxystrobin, pyraclostrobin, iprodione, fludioxonyl, propiconazole, epoxiconazole, cyproconazole, tebuconazole, procymidone fluazinam, carbendazim, Metominostrobin.

In a further preferred embodiment, a combination according to the invention comprises a DMI, preferably Fluquinconazole or Mefentrifluconazole, and at least one insecticide for example and preferably selected from imidacloprid, clothianidin, thiacloprid, thiamethoxm, spinosad, spinoteram, chloranthraniliprole, flubendiamide, cyantraniliprole, flupyradifuron, sulfoxaflor, avermectin, thiodicarb, methiocarb and at least one fungicide for example and preferably selected from prothioconazole, azoxystrobin, picoxystrobin, pyraclostrobin, iprodione, fludioxonyl, propiconazole, epoxiconazole, cyproconazole, tebuconazole, procymidone fluazinam, carbendazim, Metominostrobin.

In a further preferred embodiment, a combination according to the invention comprises a DMI, preferably Fluquinconazole or Mefentrifluconazole, and a fungicide for example and preferably selected from prothioconazole, azoxystrobin, picoxystrobin, pyraclostrobin, iprodione, fludioxonyl, propiconazole, epoxiconazole, cyproconazole, tebuconazole, procymidone fluazinam, carbendazim, Metominostrobin.

In a further preferred embodiment, a combination according to the invention comprises a DMI, preferably Fluquinconazole or Mefentrifluconazole, and an insecticide for example and preferably selected from imidacloprid, clothianidin, thiacloprid, thiamethoxm, spinosad, spinoteram, chloranthraniliprole, flubendiamide, cyantraniliprole, flupyradifuron, sulfoxaflor, avermectin, thiodicarb, methiocarb and a fungicide for example and preferably selected from prothioconazole, azoxystrobin, picoxystrobin, pyraclostrobin, iprodione, fludioxonyl, propiconazole, epoxiconazole, cyproconazole, tebuconazole, procymidone fluazinam, carbendazim, metominostrobin.

The present invention accordingly provides for the use of a DMI, preferably Fluquinconazole or Mefentrifluconazole, for control of Sclerotinia sclerotiorum as a seed treatment with excellent phytocompatibility.

Surprisingly, a DMI, preferably Fluquinconazole or Mefentrifluconazole, is particularly potent against Sclerotinia spp. as a seed treatment, preferably to control Sclerotinia spp. in soybean.

In the context of the present invention, “control of Sclerotinia spp.” means a significant reduction in primary infection by Sclerotinia spp., compared with the untreated plant, preferably a significant reduction (by a value of between 40-79% compared to an untreated control plant), compared with the untreated plant (100%); more preferably, the primary infection by Sclerotinia spp. is entirely suppressed (by a value of between 80-100% compared to an untreated control plant). The control is for protection of plants which have not yet been infected.

In one preferred embodiment, the above reduction in primary infection by Sclerotinia spp., compared with the untreated plant is of at least 40%, more preferably at least 60%, even more preferably at least 70%. Preferably, the reduction is achieved by a DMI, preferably Fluquinconazole or Mefentrifluconazole.

In another preferred embodiment, this reduction of at least 40%, more preferably at least 60%, even more preferably at least 70% is achieved by using at most 200 g a.i./100 kg seed, such as at most 150 g a.i./100 kg seed or such as at most 140 g a.i./100 kg seed. Preferably the a.i. is a DMI, preferably Fluquinconazole or Mefentrifluconazole.

In another preferred embodiment, this reduction of at least 40%, more preferably at least 60%, even more preferably at least 70% is achieved by using at most 200 g a.i./100 kg soybeansoybean seed, such as at most 150 g a.i./100 kg soybean seed or such as at most 140 g a.i./100 kg soybean seed. Preferably the a.i. is a DMI, preferably Fluquinconazole or Mefentrifluconazole.

In yet another preferred embodiment, this reduction of at least 40%, more preferably at least 60%, even more preferably at least 70% is achieved by using at most 200 g of a DMI, preferably Fluquinconazole or Mefentrifluconazole/100 kg soybean seed, such as at most 150 g of a DMI, preferably Fluquinconazole or Mefentrifluconazole/100 kg soybean seed or such as at most 140 g of a DMI, preferably Fluquinconazole or Mefentrifluconazole/100 kg soybean seed.

More particularly, the inventive use exhibits the advantages described on plants and plant parts or seed in spray application, in seed treatment, in drip and drench applications, in-furrow applications, on-seed application and overall soil incorporation, chemigation, i.e. by addition of the active ingredients to the irrigation water, and in hydroponic/mineral systems.

Combinations of a DMI, preferably Fluquinconazole or Mefentrifluconazole, with substances including insecticides, fungicides and bactericides, fertilizers, growth regulators, can likewise find use in the control of plant diseases in the context of the present invention. The combined use of a DMI, preferably Fluquinconazole or Mefentrifluconazole, with genetically modified cultivars, especially of transgenic soybean cultivars, is additionally likewise possible.

In the context of the present invention, a plant is preferably understood to mean a plant at or after the stage of leaf development (at or after BBCH stage 10 according to the BBCH monograph from the German Federal Biological Research Centre for Agriculture and Forestry, 2nd edition, 2001). In the context of the present invention, the term “plant” is also understood to mean seed or seedlings.

Seed Treatment

Most preferred is the protection of soybean plants by seed treatment with a succinate dehydrogenase inhibitor (SDHI), most preferably Pyraziflumid, or compositions comprising the same, or a compound of formula (II), or Quinofumelin, or HPDI (FRAC classification P) more preferably Isotianil or a plant host defence inducer compound of formula (V), or a C14-Demethylase Inhibitor (DMI, see FRAC classification G1) more preferably Fluquinconazole or Mefentrifluconazole.

The treatment of the seed of plants has been known for a long time and is the subject of constant improvements. Nevertheless, the treatment of seed gives rise to a series of problems which cannot always be solved in a satisfactory manner. For instance, it is desirable to develop methods for protecting the seed, the germinating plant and the resulting plants or plant parts, which dispense with, or at least significantly reduce, the additional deployment of crop protection products after planting or after emergence of the plants. It is additionally desirable to optimize the amount of active ingredient used in such a way as to provide the best possible protection for the seed and the germinating plant from attack by Sclerotinia spp., but without damaging the plant itself by the active ingredient used.

The present invention therefore relates more particularly also to a method for treating seed to control Sclerotinia spp. in the plants which grow from the seed, by treating the seed with a succinate dehydrogenase inhibitor (SDHI), most preferably Pyraziflumid, or compositions comprising the same, or a compound of formula (II), or Quinofumelin, or HPDI (FRAC classification P) more preferably Isotianil or A plant host defence inducer compound of formula (V), or a C14-Demethylase Inhibitor (DMI, see FRAC classification G1) more preferably Fluquinconazole or Mefentrifluconazole. The seed is more preferably soybean for example.

The invention likewise relates to the use of a succinate dehydrogenase inhibitor (SDHI), most preferably Pyraziflumid, or compositions comprising the same, or a compound of formula (II), or Quinofumelin, or HPDI (FRAC classification P) more preferably Isotianil or A plant host defence inducer compound of formula (V), or a C14-Demethylase Inhibitor (DMI, see FRAC classification G1) more preferably Fluquinconazole or Mefentrifluconazole for treatment of seed to control Sclerotinia spp in the seed.

Another embodiment refers to the use of a succinate dehydrogenase inhibitor (SDHI), most preferably Pyraziflumid, or compositions comprising the same, or a compound of formula (II), or Quinofumelin, or HPDI (FRAC classification P) more preferably Isotianil or A plant host defence inducer compound of formula (V), or a C14-Demethylase Inhibitor (DMI, see FRAC classification G1) more preferably Fluquinconazole or Mefentrifluconazole to control Sclerotinia spp on a germinating plant.

Yet another embodiment, embodiment refers to the use of a succinate dehydrogenase inhibitor (SDHI), most preferably Pyraziflumid, or compositions comprising the same, or a compound of formula (II), or Quinofumelin, or HPDI (FRAC classification P) more preferably Isotianil or A plant host defence inducer compound of formula (V), or a C14-Demethylase Inhibitor (DMI, see FRAC classification G1) more preferably Fluquinconazole or Mefentrifluconazole for control Sclerotinia spp on a plant or plant parts which grow therefrom.

It is likewise considered to be advantageous that a succinate dehydrogenase inhibitor (SDHI), most preferably Pyraziflumid, or compositions comprising the same, or a compound of formula (II), or

Quinofumelin, or HPDI (FRAC classification P) more preferably Isotianil or A plant host defence inducer compound of formula (V), or a C14-Demethylase Inhibitor (DMI, see FRAC classification G1) more preferably Fluquinconazole or Mefentrifluconazole can especially also be used in transgenic seed.

In the context of the present invention, a succinate dehydrogenase inhibitor (SDHI), most preferably Pyraziflumid, or compositions comprising the same, or a compound of formula (II), or Quinofumelin, or

HPDI (FRAC classification P) more preferably Isotianil or A plant host defence inducer compound of formula (V), or a C14-Demethylase Inhibitor (DMI, see FRAC classification G1) more preferably Fluquinconazole or Mefentrifluconazole is applied to the seed alone or in a suitable formulation. Preferably, the seed is treated in a state in which it is stable enough to avoid damage during treatment. In general, the seed may be treated at any time between harvest and sowing. The seed typically used has been separated from the plant and freed from cobs, shells, stalks, coats, hairs or the fruit flesh. For example, it is possible to use seed which has been harvested, cleaned and dried to a moisture content of less than 15% by weight. Alternatively, it is also possible to use seed which, after drying, for example, has been treated with water and then dried again.

When treating the seed, it must generally be ensured that the amount of a succinate dehydrogenase inhibitor (SDHI), most preferably Pyraziflumid, or compositions comprising the same, or a compound of formula (II), or Quinofumelin, or HPDI (FRAC classification P) more preferably Isotianil or A plant host defence inducer compound of formula (V), or a C14-Demethylase Inhibitor (DMI, see FRAC classification G1) more preferably Fluquinconazole or Mefentrifluconazole, applied to the seed and/or of further additives is selected such that the germination of the seed is not impaired, and that the resulting plant is not damaged. This should be noted in particular in the case of active ingredients which can have phytotoxic effects at particular application rates

A succinate dehydrogenase inhibitor (SDHI), most preferably Pyraziflumid, or compositions comprising the same, or a compound of formula (II), or Quinofumelin, or HPDI (FRAC classification P) more preferably Isotianil or A plant host defence inducer compound of formula (V), or a C14-Demethylase Inhibitor (DMI, see FRAC classification G1) more preferably Fluquinconazole or Mefentrifluconazole, can be applied directly, i.e. without containing any further components and without having been diluted. In general, it is preferable to apply the active ingredients according to this invention, a succinate dehydrogenase inhibitor (SDHI), most preferably Pyraziflumid, or compositions comprising the same, or a compound of formula (II), or Quinofumelin, or HPDI (FRAC classification P) more preferably Isotianil or A plant host defence inducer compound of formula (V), or a C14-Demethylase Inhibitor (DMI, see FRAC classification G1) more preferably Fluquinconazole or Mefentrifluconazole, to the seed in the form of a suitable formulation. Suitable formulations and methods for seed treatment are known to those skilled in the art and are described, for example, in the following documents: U.S. Pat. Nos. 4,272,417 A, 4,245,432 A, 4,808,430 A, 5,876,739 A, US 2003/0176428 A1, WO 2002/080675 A1, WO 2002/028186 A2.

A succinate dehydrogenase inhibitor (SDHI), most preferably Pyraziflumid, or compositions comprising the same, or a compound of formula (II), or Quinofumelin, or HPDI (FRAC classification P) more preferably Isotianil or A plant host defence inducer compound of formula (V), or a C14-Demethylase Inhibitor (DMI, see FRAC classification G1) more preferably Fluquinconazole or Mefentrifluconazole, can be converted to the customary seed dressing formulations, such as solutions, emulsions, suspensions, powders, foams, slurries or other coating materials for seed.

These formulations are produced in a known manner, by mixing the active ingredients or active ingredient combinations with customary additives, for example customary extenders and solvents or diluents, dyes, wetting agents, dispersants, emulsifiers, defoamers, preservatives, secondary thickeners, stickers, gibberellins and also water.

Useful dyes which may be present in the seed dressing formulations usable in accordance with the invention are all dyes customary for such purposes. It is possible to use both sparingly water-soluble pigments and water-soluble dyes. Examples include the dyes known under the Rhodamine B, C.I. Pigment Red 112 and C.I. Solvent Red 1 names.

The wetting agents which may be present in the seed dressing formulations usable in accordance with the invention include all substances which promote wetting and are customary for formulation of active agrochemical ingredients. Usable with preference are alkyl naphthalenesulphonates, such as diisopropyl or diisobutyl naphthalenesulphonate.

The dispersants and/or emulsifiers which may be present in the seed dressing formulations usable in accordance with the invention include all nonionic, anionic and cationic disperants which are customary for formulation of active agrochemical ingredients. Usable with preference are nonionic or anionic dispersants or mixtures of nonionic or anionic dispersants. Suitable nonionic dispersants include especially ethylene oxide-propylene oxide block polymers, alkylphenol polyglycol ethers and tristyrylphenol polyglycol ethers, and the phosphated or sulphated derivatives thereof. Suitable anionic dispersants are especially lignosulphonates, polyacrylic acid salts and arylsulphonate-formaldehyde condensates.

The defoamers which may be present in the seed dressing formulations usable in accordance with the invention include all foam-inhibiting substances customary for formulation of active agrochemical ingredients. Usable with preference are silicone defoamers and magnesium stearate.

The preservatives which may be present in the seed dressing formulations usable in accordance with the invention include all substances usable for such purposes in agrochemical formulations. Examples include dichlorophene and benzyl alcohol hemiformal.

Useful secondary thickeners which may be present in the seed dressing formulations usable in accordance with the invention include all substances usable for such purposes in agrochemical formulations. Preferred examples include cellulose derivatives, acrylic acid derivatives, xanthan, modified clays and finely divided silica.

Useful stickers which may be present in the seed dressing formulations usable in accordance with the invention are all customary binders usable in seed dressing compositions. Preferred examples include polyvinylpyrrolidone, polyvinyl acetate, polyvinyl alcohol and tylose.

For treatment of seed with the seed dressing formulations usable in accordance with the invention, or the preparations prepared therefrom by adding water, all mixing units usable customarily for the seed dressing are useful. Specifically, the seed dressing procedure is to introduce the seed into a mixer, to add the particular desired amount of seed dressing formulations, either as such or after preceding dilution with water, and to mix until the formulation is distributed homogeneously on the seed. This may be followed by a drying operation.

The application rate of seed dressing formulations usable in accordance with the invention may vary within a relatively wide range. It is guided by the particular content of the active ingredients in the formulations and by the seed. The application rates of active ingredient combinations are generally between 0.001 and 50 g per kilogram of seed, preferably between 0.01 and 5 g per kilogram of seed, very preferably between 0.01 an 3 g per kilogram of seed. Particular preference is given in accordance with the invention to treating plants of the plant cultivars which are each commercially available or in use. Plant cultivars are understood to mean plants which have new properties (“traits”) and which have been obtained by conventional breeding, by mutagenesis or with the aid of recombinant DNA techniques. Crop plants may accordingly be plants which can be obtained by conventional breeding and optimization methods or by biotechnology and genetic engineering methods or combinations of these methods, including the transgenic plants and including the plant varieties which can and cannot be protected by plant variety rights.

The method according to the invention can thus also be used for the treatment of genetically modified organisms (GMOs), for example plants or seeds. Genetically modified plants (or transgenic plants) are plants in which a heterologous gene has been integrated stably into the genome. The term “heterologous gene” means essentially a gene which is provided or assembled outside the plant and which, on introduction into the cell nucleus genome, imparts new or improved agronomic or other properties to the chloroplast genome or the mitochondrial genome of the transformed plant by virtue of it expressing a protein or polypeptide of interest or by virtue of another gene which is present in the plant, or other genes which are present in the plant, being downregulated or silenced (for example by means of antisense technology, co-suppression technology or RNA technology [RNA interference]). A heterologous gene present in the genome is likewise referred to as a transgene. A transgene which is defined by its specific presence in the plant genome is referred to as a transformation or transgenic event.

Plants and plant cultivars which are preferably treated according to the invention include all plants which have genetic material which imparts particularly advantageous, useful traits to these plants (whether obtained by breeding and/or biotechnological means).

Plants and plant cultivars which may also be treated in according to invention are those plants which are resistant to one or more abiotic stresses. Abiotic stress conditions may include, for example, drought, cold temperature exposure, heat exposure, osmotic stress, flooding, increased soil salinity, increased mineral exposure, ozone exposure, high light exposure, limited availability of nitrogen nutrients, limited availability of phosphorus nutrients or shade avoidance.

Plants and plant cultivars which may also be treated according to the invention are those plants characterized by enhanced yield characteristics. Increased yield in said plants can be the result of, for example, improved plant physiology, growth and development, such as water use efficiency, water retention efficiency, improved nitrogen use, enhanced carbon assimilation, improved photosynthesis, increased germination efficiency and accelerated maturation. Yield can furthermore be affected by improved plant architecture (under stress and non-stress conditions), including but not limited to early flowering, flowering control for hybrid seed production, seedling vigour, plant size, internode number and distance, root growth, seed size, fruit size, pod size, pod or ear number, seed number per pod or ear, seed mass, enhanced seed filling, reduced seed dispersal, reduced pod dehiscence and lodging resistance. Further yield traits include seed composition, such as carbohydrate content, protein content, oil content and composition, nutritional value, reduction in anti-nutritional compounds, improved processability and better storage stability.

Plants that may also be treated according to the invention are hybrid plants that already express the characteristic of heterosis or hybrid vigour which generally results in higher yield, vigour, health and resistance towards biotic and abiotic stress factors. Such plants are typically made by crossing an inbred male-sterile parent line (the female parent) with another inbred male-fertile parent line (the male parent). Hybrid seed is typically harvested from the male sterile plants and sold to growers. Male sterile plants can sometimes (e.g. in maize) be produced by detasseling, i.e. the mechanical removal of the male reproductive organs (or male flowers), but, more typically, male sterility is the result of genetic determinants in the plant genome. In that case, and especially when seed is the desired product to be harvested from the hybrid plants, it is typically useful to ensure that male fertility in hybrid plants that contain the genetic determinants responsible for the male sterility is fully restored. This can be accomplished by ensuring that the male parents have appropriate fertility restorer genes which are capable of restoring the male fertility in hybrid plants that contain the genetic determinants responsible for male sterility. Genetic determinants for male sterility may be located in the cytoplasm. Examples of cytoplasmatic male sterility (CMS) were for instance described in Brassica species (WO 1992/005251, WO 1995/009910, WO 1998/27806, WO 2005/002324, WO 2006/021972 and U.S. Pat. No. 6,229,072). However, genetic determinants for male sterility can also be located in the nuclear genome. Male-sterile plants can also be obtained by plant biotechnology methods such as genetic engineering. A particularly useful means of obtaining male-sterile plants is described in WO 89/10396, in which, for example, a ribonuclease such as barnase is selectively expressed in the tapetum cells in the stamens. Fertility can then be restored by expression in the tapetum cells of a ribonuclease inhibitor such as barstar (e.g. WO 1991/002069).

Plants or plant cultivars (obtained by plant biotechnology methods such as genetic engineering) which may likewise be treated according to the invention are herbicide-tolerant plants, i.e. plants made tolerant to one or more given herbicides. Such plants can be obtained either by genetic transformation, or by selection of plants containing a mutation imparting such herbicide tolerance.

Herbicide-tolerant plants are for example glyphosate-tolerant plants, i.e. plants made tolerant to the herbicide glyphosate or salts thereof. For example, glyphosate-tolerant plants can be obtained by transforming the plant with a gene encoding the enzyme 5-enolpyruvylshikimate-3-phosphate synthase (EPSPS). Examples of such EPSPS genes are the AroA gene (mutant CT7) of the bacterium Salmonella typhimurium (Comai et al., Science (1983), 221, 370-371), the CP4 gene of the bacterium Agrobacterium sp. (Barry et al., Curr. Topics Plant Physiol. (1992), 7, 139-145), the genes encoding a petunia EPSPS (Shah et al., Science (1986), 233, 478-481), a tomato EPSPS (Gasser et al., J. Biol. Chem. (1988), 263, 4280-4289) or an Eleusine EPSPS (WO 2001/66704). It can also be a mutated EPSPS, as described, for example, in EP-A 0837944, WO 2000/066746, WO 2000/066747 or WO 2002/026995. Glyphosate-tolerant plants can also be obtained by expressing a gene that encodes a glyphosate oxidoreductase enzyme as described in U.S. Pat. Nos. 5,776,760 and 5,463,175. Glyphosate-tolerant plants can also be obtained by expressing a gene that encodes a glyphosate acetyl transferase enzyme as described, for example, in WO 2002/036782, WO 2003/092360, WO 2005/012515 and WO 2007/024782. Glyphosate-tolerant plants can also be obtained by selecting plants containing naturally occurring mutations of the above-mentioned genes as described, for example, in WO 2001/024615 or WO 2003/013226.

Other herbicide-resistant plants are for example plants that have been made tolerant to herbicides inhibiting the enzyme glutamine synthase, such as bialaphos, phosphinothricin or glufosinate. Such plants can be obtained by expressing an enzyme detoxifying the herbicide or a mutant glutamine synthase enzyme that is resistant to inhibition. One such efficient detoxifying enzyme is, for example, an enzyme encoding a phosphinothricin acetyltransferase (such as the bar or pat protein from Streptomyces species). Plants expressing an exogenous phosphinothricin acetyltransferase are for example described in U.S. Pat. Nos. 5,561,236; 5,648,477; 5,646,024; 5,273,894; 5,637,489; 5,276,268; 5,739,082; 5,908,810 and 7,112,665.

Further herbicide-tolerant plants are also plants that have been made tolerant to the herbicides inhibiting the enzyme hydroxyphenylpyruvatedioxygenase (HPPD). Hydroxyphenylpyruvatedioxygenases are enzymes that catalyse the reaction in which para-hydroxyphenylpyruvate (HPP) is transformed into homogentisate. Plants tolerant to HPPD-inhibitors can be transformed with a gene encoding a naturally occurring resistant HPPD enzyme, or a gene encoding a mutated HPPD enzyme according to WO 1996/038567, WO 1999/024585 and WO 1999/024586. Tolerance to HPPD inhibitors can also be obtained by transforming plants with genes encoding certain enzymes enabling the formation of homogentisate despite the inhibition of the native HPPD enzyme by the HPPD inhibitor. Such plants and genes are described in WO 1999/034008 and WO 2002/36787. Tolerance of plants to HPPD inhibitors can also be improved by transforming plants with a gene encoding an enzyme prephenate dehydrogenase in addition to a gene encoding an HPPD-tolerant enzyme, as described in WO 2004/024928.

Further herbicide-resistant plants are plants that have been made tolerant to acetolactate synthase (ALS) inhibitors. Known ALS-inhibitors include, for example, sulphonylurea, imidazolinone, triazolopyrimidines, pyrimidinyloxy (thio)benzoates, and/or sulphonylaminocarbonyltriazolinone herbicides. Different mutations in the ALS enzyme (also known as acetohydroxyacid synthase, AHAS) are known to confer tolerance to different herbicides and groups of herbicides, as described for example in Tranel and Wright, Weed Science (2002), 50, 700-712, but also in U.S. Pat. Nos. 5,605,011, 5,378,824, 5,141,870 and 5,013,659. The production of sulphonylurea-tolerant plants and imidazolinone-tolerant plants is described in U.S. Pat. Nos. 5,605,011; 5,013,659; 5,141,870; 5,767,361; 5,731,180; 5,304,732; 4,761,373; 5,331,107; 5,928,937; and 5,378,824; and international publication WO 1996/033270. Other imidazolinone-tolerant plants are also described in for example WO 2004/040012, WO 2004/106529, WO 2005/020673, WO 2005/093093, WO 2006/007373, WO 2006/015376, WO 2006/024351 and WO 2006/060634. Further sulphonylurea- and imidazolinone-tolerant plants are also described in for example WO 2007/024782.

Other plants tolerant to imidazolinone and/or sulphonylurea can be obtained by induced mutagenesis, selection in cell cultures in the presence of the herbicide or by mutation breeding as described for example for soybean beans in U.S. Pat. No. 5,084,082, for rice in WO 1997/41218, for sugar beet in U.S. Pat. No. 5,773,702 and WO 1999/057965, for lettuce in U.S. Pat. No. 5,198,599 or for sunflower in WO 2001/065922.

Plants or plant cultivars (obtained by plant biotechnology methods such as genetic engineering) which may also be treated according to the invention are insect-resistant transgenic plants, i.e. plants made resistant to attack by certain target insects. Such plants can be obtained by genetic transformation, or by selection of plants containing a mutation imparting such insect resistance.

The term “insect-resistant transgenic plant”, as used herein, includes any plant containing at least one transgene comprising a coding sequence encoding:
1) an insecticidal crystal protein from Bacillus thuringiensis or an insecticidal portion thereof, such as the insecticidal crystal proteins listed by Crickmore et al., Microbiology and Molecular Biology Reviews (1998), 62, 807-813, updated by Crickmore et al. (2005) in the Bacillus thuringiensis toxin nomenclature, online at:
   http://www.lifesci.sussex.ac.uk/Home/Neil_Crickmore/Bt/), or insecticidal portions thereof, e.g. proteins of the Cry protein classes Cry1Ab, Cry1Ac, Cry1F, Cry2Ab, Cry3Ae or Cry3Bb or insecticidal portions thereof; or
2) a crystal protein from Bacillus thuringiensis or a portion thereof which is insecticidal in the presence of a second other crystal protein from Bacillus thuringiensis or a portion thereof, such as the binary toxin made up of the Cy34 and Cy35 crystal proteins (Moellenbeck et al., Nat. Biotechnol. (2001), 19, 668-72; Schnepf et al., Applied Environm. Microb. (2006), 71, 1765-1774); or
3) a hybrid insecticidal protein comprising parts of two different insecticidal crystal proteins from Bacillus thuringiensis, such as a hybrid of the proteins of 1) above or a hybrid of the proteins of 2) above, e.g. the Cry1A.105 protein produced by maize event MON98034 (WO 2007/027777); or
4) a protein of any one of points 1) to 3) above wherein some, particularly 1 to 10, amino acids have been replaced by another amino acid to obtain a higher insecticidal activity to a target insect species, and/or to expand the range of target insect species affected, and/or because of changes induced in the encoding DNA during cloning or transformation, such as the Cry3Bb1 protein in maize events MON863 or MON88017, or the Cry3A protein in maize event MIR604; or
5) an insecticidal secreted protein from Bacillus thuringiensis or Bacillus cereus, or an insecticidal portion thereof, such as the vegetative insecticidal proteins (VIP) listed at: http://www.lifesci.sussex.ac.uk/home/Neil_Crickmore/Bt/vip.html, e.g. proteins from the VIP3Aa protein class; or
6) a secreted protein from Bacillus thuringiensis or Bacillus cereus which is insecticidal in the presence of a second secreted protein from Bacillus thuringiensis or B. cereus, such as the binary toxin made up of the VIP1A and VIP2A proteins (WO 1994/21795); or
7) a hybrid insecticidal protein comprising parts from different secreted proteins from Bacillus thuringiensis or Bacillus cereus, such as a hybrid of the proteins in 1) above or a hybrid of the proteins in 2) above; or
8) a protein of any one of points 1) to 3) above wherein some, particularly 1 to 10, amino acids have been replaced by another amino acid to obtain a higher insecticidal activity to a target insect species, and/or to expand the range of target insect species affected, and/or because of changes induced in the encoding DNA during cloning or transformation (while still encoding an insecticidal protein), such as the VIP3Aa protein in cotton event COT102.

Of course, insect-resistant transgenic plants, as used herein, also include any plant comprising a combination of genes encoding the proteins of any one of the abovementioned classes 1 to 8. In one embodiment, an insect-resistant plant contains more than one transgene encoding a protein of any one of the abovementioned classes 1 to 8, to expand the range of target insect species affected or to delay insect resistance development to the plants, by using different proteins insecticidal to the same target insect species but having a different mode of action, such as binding to different receptor binding sites in the insect.

Plants or plant cultivars (obtained by plant biotechnology methods such as genetic engineering) which may also be treated according to the invention are tolerant to abiotic stress factors. Such plants can be obtained by genetic transformation, or by selection of plants containing a mutation imparting such stress resistance. Particularly useful stress-tolerant plants include:
a. plants which contain a transgene capable of reducing the expression and/or the activity of the poly(ADP-ribose)polymerase (PARP) gene in the plant cells or plants as described in WO 2000/004173 or EP 04077984.5 or EP 06009836.5;
b. plants which contain a stress tolerance-enhancing transgene capable of reducing the expression and/or the activity of the PARG encoding genes of the plants or plant cells as described, for example, in WO 2004/090140;
c. plants which contain a stress tolerance-enhancing transgene coding for a plant-functional enzyme of the nicotinamide adenine dinucleotide salvage biosynthesis pathway, including nicotinamidase, nicotinate phosphoribosyltransferase, nicotinic acid mononucleotide adenyltransferase, nicotinamide adenine dinucleotide synthetase or nicotinamide phosphoribosyltransferase as described, for example, in EP 04077624.7 or WO 2006/133827 or PCT/EP07/002433.

Plants or plant cultivars (obtained by plant biotechnology methods such as genetic engineering) which may also be treated according to the invention show altered quantity, quality and/or storage stability of the harvested product and/or altered properties of specific ingredients of the harvested product such as:
1) transgenic plants which synthesize a modified starch, which in its physicochemical characteristics, in particular the amylose content or the amylose/amylopectin ratio, the degree of branching, the average chain length, the side chain distribution, the viscosity behaviour, the gelling strength, the starch grain size and/or the starch grain morphology, is changed in comparison with the synthesized starch in wild type plant cells or plants, so that this modified starch is better suited for special applications. Said transgenic plants synthesizing a modified starch are described, for example, in EP 0571427, WO 1995/004826, EP 0719338, WO 1996/15248, WO 1996/19581, WO 1996/27674, WO 1997/11188, WO 1997/26362, WO 1997/32985, WO 1997/42328, WO 1997/44472, WO 1997/45545, WO 1998/27212, WO 1998/40503, WO 99/58688, WO 1999/58690, WO 1999/58654, WO 2000/008184, WO 2000/008185, WO 2000/28052, WO 2000/77229, WO 2001/12782, WO 2001/12826, WO 2002/101059, WO 2003/071860, WO 2004/056999, WO 2005/030942, WO 2005/030941, WO 2005/095632, WO 2005/095617, WO 2005/095619, WO 2005/095618, WO 2005/123927, WO 2006/018319, WO 2006/103107, WO 2006/108702, WO 2007/009823, WO 2000/22140, WO 2006/063862, WO 2006/072603, WO 2002/034923, EP 06090134.5, EP 06090228.5, EP 06090227.7, EP 07090007.1, EP 07090009.7, WO 2001/14569, WO 2002/79410, WO 2003/33540, WO 2004/078983, WO 2001/19975, WO 1995/26407, WO 1996/34968, WO 1998/20145, WO 1999/12950, WO 1999/66050, WO 1999/53072, U.S. Pat. No. 6,734,341, WO 2000/11192, WO 1998/22604, WO 1998/32326, WO 2001/98509, WO 2001/98509, WO 2005/002359, U.S. Pat. Nos. 5,824,790, 6,013,861, WO 1994/004693, WO 1994/009144, WO 1994/11520, WO 1995/35026 and WO 1997/20936.
2) transgenic plants which synthesize non-starch carbohydrate polymers or which synthesize non-starch carbohydrate polymers with altered properties in comparison to wild type plants without genetic modification. Examples are plants producing polyfructose, especially of the inulin and levan type, as described in EP 0663956, WO 1996/001904, WO 1996/021023, WO 1998/039460 and WO 1999/024593, plants producing alpha-1,4-glucans, as described in WO 1995/031553, US 2002/031826, U.S. Pat. Nos. 6,284,479, 5,712,107, WO 1997/047806, WO 1997/047807, WO 1997/047808 and WO 2000/14249, plants producing alpha-1,6-branched alpha-1,4-glucans, as described in WO 2000/73422, and plants producing alternan, as described in WO 2000/047727, EP 06077301.7, U.S. Pat. No. 5,908,975 and EP 0728213.
3) transgenic plants which produce hyaluronan, as for example described in WO 2006/032538, WO 2007/039314, WO 2007/039315, WO 2007/039316, JP 2006/304779 and WO 2005/012529.

Plants or plant cultivars (obtained by plant biotechnology methods such as genetic engineering) which may also be treated according to the invention are plants, such as cotton plants, with altered fibre characteristics. Such plants can be obtained by genetic transformation, or by selection of plants containing a mutation imparting such altered fibre characteristics and include:
a) plants, such as cotton plants, containing an altered form of cellulose synthase genes as described in WO 1998/000549,
b) plants, such as cotton plants, containing an altered form of rsw2 or rsw3 homologous nucleic acids as described in WO 2004/053219;
c) plants, such as cotton plants, with increased expression of sucrose phosphate synthase as described in WO 2001/017333;
d) plants, such as cotton plants, with increased expression of sucrose synthase as described in WO 02/45485;
e) plants, such as cotton plants, wherein the timing of the plasmodesmatal gating at the basis of the fibre cell is altered, for example through downregulation of fibre-selective β-1,3-glucanase as described in WO 2005/017157;
f) plants, such as cotton plants, having fibres with altered reactivity, e.g. through the expression of the N-acetylglucosaminetransferase gene including nodC and chitin synthase genes as described in WO 2006/136351.

Plants or plant cultivars (that can be obtained by plant biotechnology methods such as genetic engineering) which may also be treated according to the invention are plants, such as oilseed rape or related Brassica plants, with altered oil profile characteristics. Such plants can be obtained by genetic transformation or by selection of plants containing a mutation imparting such altered oil characteristics and include:
a) plants, such as oilseed rape plants, producing oil having a high oleic acid content, as described, for example, in U.S. Pat. Nos. 5,969,169, 5,840,946 or 6,323,392 or 6,063,947;
b) plants, such as oilseed rape plants, producing oil having a low linolenic acid content, as described in U.S. Pat. Nos. 6,270,828, 6,169,190 or 5,965,755.
c) plants, such as oilseed rape plants, producing oil having a low level of saturated fatty acids, as described, for example, in U.S. Pat. No. 5,434,283.

Particularly useful transgenic plants which may be treated according to the invention are plants which comprise one or more genes which encode one or more toxins are the transgenic plants which are sold under the following trade names: YIELD GARD® (for example maize, cotton, soybean beans), KnockOut® (for example maize), BiteGard® (for example maize), BT-Xtra® (for example maize), StarLink® (for example maize), Bollgard® (cotton), Nucotn® (cotton), Nucotn 33B® (cotton), NatureGard® (for example maize), Protecta® and NewLeaf® (potato). Examples of herbicide-tolerant plants which may be mentioned are maize varieties, cotton varieties and soybean bean varieties which are sold under the following trade names: Roundup Ready® (tolerance to glyphosate, for example maize, cotton, soybean bean), Liberty Link® (tolerance to phosphinotricin, for example oilseed rape), IMI® (tolerance to imidazolinones) and SCS® (tolerance to sulphonylureas), for example maize Herbicide-resistant plants (plants bred in a conventional manner for herbicide tolerance) which may be mentioned include the varieties sold under the Clearfield® name (for example maize).

Particularly useful transgenic plants which may be treated according to the invention are plants containing transformation events, or a combination of transformation events, that are listed for example in the databases from various national or regional regulatory agencies (see for example http://gmoinfojrc.it/gmp_browse.aspx and http://www.agbios.com/dbase.php).

Formulations:

A succinate dehydrogenase inhibitor (SDHI), most preferably Pyraziflumid, or compositions comprising the same, or a compound of formula (II), or Quinofumelin, or HPDI (FRAC classification P) more preferably Isotianil or A plant host defence inducer compound of formula (V), or a C14-Demethylase Inhibitor (DMI, see FRAC classification G1) more preferably Fluquinconazole or Mefentrifluconazole, or compositions comprising the same, may be present in its commercially available formulations and in the use forms, prepared from these formulations, as a mixture with other active ingredients, such as insecticides, attractants, sterilants, bactericides, acaricides, nematicides, fungicides, growth regulators, herbicides, safeners, fertilizers or semiochemicals.

In addition, the described positive effect of a succinate dehydrogenase inhibitor (SDHI), most preferably Pyraziflumid, or compositions comprising the same, or a compound of formula (II), or Quinofumelin, or HPDI (FRAC classification P) more preferably Isotianil or A plant host defence inducer compound of formula (V), or a C14-Demethylase Inhibitor (DMI, see FRAC classification G1) more preferably Fluquinconazole or Mefentrifluconazole, on the control of Sclerofinia spp. can be promoted by an additional treatment with insecticidal, fungicidal or bactericidal active ingredients.

The examples which follow serve to illustrate the invention, but without restricting it.

### EXAMPLE A

Control Efficacy Against Sclerotinia sclerotiorum in Soybean by Seed Treatment with Pyraziflumid

The test is performed under greenhouse conditions.

Soybean seeds, treated to the desired dosages with the active compound solved in N-methyl-2-pyrrolidon and diluted with water, were sown in 6×6 cm pots (one seed per pot) filled with 1:1 mixture of steamed loam soil and quartz sand.

The plants were grown at 24° C. and 90% relative humidity in a greenhouse. Ascospores of Sclerotinia sclerotiorum were collected from 3 month old asci. Whole aerial surface of 19-25-day-old seedlings were sprayed with water suspension of the ascospores. The plants were kept for 48-96 hours in the dark at 24° C. and a relative humidity of 99%.

Assessment consisted of evaluation of infected area of the unifoliate leaves. Zero % means infection which corresponds to that of the untreated check, while an efficacy of 100% means that no infection was observed.

The table below clearly shows that the tested compound I has excellent control efficacy against ascospore infection of Sclerotinia Sclerotiorum without giving any damage on soybean plants.

The control efficacy is based on % infected leaf area.

Each test was performed at different times (e.g. due to different seasonal variations of light etc.) leading to different inoculation times after sowing to have comparable toughness of leaves etc. Moreover, the tests were performed with different batches of plants.

Control Efficacy Against Sclerotinia sclerotiorum in Soybean by Seed Treatment

Test 1 Incubation period: 3 days; inoculation 19 days after sowing

| | | | Damage on plants |
|---|---|---|---|
| | | | (relative growth |
| | Application rate | | inhibition in non- |
| | of active | Sclerotinia | inoculated plants |
| | compound in | sclerotiorum | compared to |
| | g a.i./100 kg | Control | untreated plants: |
| Active compounds | seed | efficacy % | in %) |
| Pyraziflumid | 25 | 96 | 0 |
| SDHI | 50 | 95 | 0 |
| 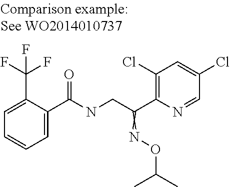 [SMILES: CC(C)ON=C(CNC(=O)c1ccccc1C(F)(F)F)c1ncc(Cl)cc1Cl] | 25 50 | 5 53 | 0 0 |
| Untreated check | 0 | (infected area: | 0 |
| | | 100%) | |

Test 2 Incubation period: 4 days; inoculation 22 days after sowing

| | | | Damage on plants |
|---|---|---|---|
| | | | (relative growth |
| | Application rate | | inhibition in non- |
| | of active | Sclerotinia | inoculated plants |
| | compound in | sclerotiorum | compared to |
| | g a.i./100 kg | Control | untreated plants: |
| Active compounds | seed | efficacy % | in %) |
| 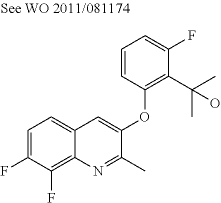 [SMILES: Cc1nc2c(F)c(F)ccc2cc1Oc1cccc(F)c1C(C)(C)O] | 140 70 | 99 0 | 0 0 |
| Pyraziflumid | 140 | 86 | 0 |
| SDHI | 70 | 58 | 0 |
| Untreated check | 0 | (infected area: | 0 |
| | | 100%) | |

Test 3 Incubation period: 2 days; inoculation 20 days after sowing

| | | | Damage on |
|---|---|---|---|
| | | | plants (relative |
| | | | growth |
| | Applica- | | inhibition |
| | tion | | in non- |
| | rate of | | inoculated |
| | active | | plants |
| | com- | Sclerotinia | compared to |
| | pound in | sclerotiorum | untreated |
| | g a.i./100 | Control | plants: |
| Active compounds | kg seed | efficacy % | in %) |
| 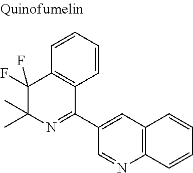 [SMILES: CC1(C)N=C(c2cnc3ccccc3c2)c2ccccc2C1(F)F] | 140 70 | 96 72 | 0 0 |
| Isotianil | 70 | 65 | 0 |
| HPDI* | 35 | 46 | 11 |
| Fluquinconazole | 50 | 86 | 0 |
| DMI** | 25 | 83 | 0 |
| Pyraziflumid | 140 | 95 | 0 |
| SDHI | 70 | 87 | 0 |
| Untreated check | 0 | (infected | 0 |
| | | area: 29%) | |

*Host plant defence inducer (FRAC MoA “P”)
**DMI C14-Demethylase Inhibitor

Test 4 Incubation period: 4 days; inoculation 25 days after sowing

| | | | Damage on |
|---|---|---|---|
| | | | plants |
| | | | (relative |
| | | | growth |
| | Applica- | | inhibition |
| | tion rate | | in non- |
| | of active | | inoculated |
| | com- | Sclerotinia | plants |
| | pound in | sclerotiorum | compared |
| | g a.i./100 | Control | to untreated |
| Active compounds | kg seed | efficacy % | plants: in %) |
| 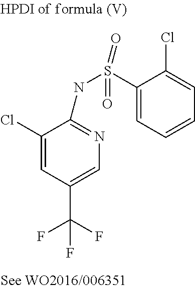 [SMILES: O=S(=O)(Nc1ncc(C(F)(F)F)cc1Cl)c1ccccc1Cl] | 50 10 | 70 73 | 8 17 |
| Pyraziflumid | 140 | 90 | 0 |
| SDHI | 70 | 80 | 0 |
| Untreated check | 0 | (infected | 0 |
| | | area: 100%) | |

Test 5 Incubation period: 2 days; inoculation 21 days after sowing

| | | | Damage on |
|---|---|---|---|
| | | | plants (relative |
| | Application | | growth inhibition |
| | rate of active | Sclerotinia | in non-inoculated |
| | compound in | sclerotiorum | plants compared |
| Active | g a.i./100 | Control | to untreated |
| compounds | kg seed | efficacy % | plants: in %) |
| Mefentrifluconazole | 25 | 84 | 10 |
| DMI | 10 | 90 | 0 |
| Pyraziflumid | 75 | 98 | 0 |
| SDHI | | | |
| Untreated check | 0 | (infected area: | 0 |
| | | 76%) | |

Test 6 Incubation period: 3 days; inoculation 22 days after sowing

| | | | Damage on |
|---|---|---|---|
| | | | plants (relative |
| | Application | | growth inhibition |
| | rate of active | Sclerotinia | in non-inoculated |
| | compound in | sclerotiorum | plants compared |
| Active | g a.i./100 | Control | to untreated |
| compounds | kg seed | efficacy % | plants: in %) |
| Quinofumelin | 140 | 1 | 0 |
| | 70 | 16 | 0 |
| Isotianil | 70 | 18 | 0 |
| | 35 | 15 | 0 |
| Fluquinconazole | 50 | 2 | 0 |
| | 25 | 0 | 0 |
| Pyraziflumid | 140 | 33 | 30 |
| | 70 | 36 | 0 |
| Untreated check | 0 | (infected area: | 0 |
| | | 100%) | |

### EXAMPLE B

Control Efficacy Against Sclerotinia sclerotiorum by Spray and Seed Treatment with Current Standards

Two tests were performed under greenhouse conditions.

spray test (dwarf beans)

Solvent: 24.5 parts by weight of acetone
24.5 parts by weight of dimethylacetamide

Emulsifier: 1 part by weight of alkylaryl polyglycol ether

To produce a suitable preparation of active compound, 1 part by weight of active compound is mixed with the stated amounts of solvent and emulsifier, and the concentrate is diluted with water to the desired concentration.

To test for preventive activity, unifoliate leaves of 10 day-old plants are sprayed with the preparation of active compound. After the spray coating has dried on, 2 small pieces of agar covered with growth of Sclerotinia sclerotiorum are placed on each leaf. The inoculated plants are placed in a darkened chamber at approximately 20° C. and a relative atmospheric humidity of 100%.

3 days after the inoculation, the size of the lesions on the leaves is evaluated. 0% means an efficacy which corresponds to that of the untreated control, while an efficacy of 100% means that no disease is observed.

Control Efficacy Against Sclerotinia sclerotiorum in Dwarf Bean by Spray

Test 7 Spray treatment Incubation period: 3 days; inoculation 10 days old plants

| | Application | Sclerotinia | |
|---|---|---|---|
| | rate of active | sclerotiorum | |
| Active | compound in | Control | Damage on |
| compounds | mg ai/Liter | efficacy % | plants (in %) |
| pydiflumetofen | 100 | 100 | 0 |
| fluopyram | 100 | 100 | 0 |
| Untreated check | 0 | (infected area: | 0 |
| | | 100%) | |

Seed Treatment Test (Soybean)

Soybean seeds, treated to the desired dosages with the active compound solved in N-methyl-2-pyrrolidon and diluted with water, were sown in 6×6 cm pots (one seed per pot) filled with 1:1 mixture of steamed loam soil and quartz sand.

The plants were grown at 24° C. and 90% relative humidity in a greenhouse. Ascospores of Sclerotinia sclerotiorum were collected from 3 month old asci. Whole aerial surface of 27 day-old seedlings were sprayed with water suspension of the ascospores. The plants were kept for 72 hours in the dark at 24° C. and a relative humidity of 99%.

Assessment consisted of evaluation of infected area of the unifoliate leaves. Zero % means infection which corresponds to that of the untreated check, while an efficacy of 100% means that no infection was observed.

The table below clearly shows that the tested compound I has excellent control efficacy against ascospore infection of Sclerotinia Sclerotiorum without giving any damage on soybean plants.

Control Efficacy Against Sclerotinia sclerotiorum in Soybean by Seed Treatment

Test 8 Seed Treatment—Incubation Period: 3 Days; Inoculation 27 Days after Sowing

| | Application | | Damage |
|---|---|---|---|
| | rate of active | Sclerotinia | on plants |
| | compound in | sclerotiorum | (emergence |
| Active | g a.i./100 | Control | inhibition |
| compounds | kg seed | efficacy % | in %) |
| pydiflumetofen | 50 | 0 | 0 |
| fluopyram | 50 | 68 | 25 |
| Untreated check | 0 | (infected area: | 0 |
| | | 100%) | |

Test 7 and test 8 show that a compound which demonstrate excellent control efficacy by foliar spray application does not necessarily show efficacy by seed treatment even at its highest safe dosage for, e.g., soybean seeds.

Especially Pyraziflumid and also the further compounds of this invention showed clear advantage in its respective efficacy at lower dosage (e.g., 25 g ai/100 kg seed for Pyraziflumid, see Test 1).

1. A method for control of Sclerotinia spp comprising using an active ingredient selected from the group consisting of a succinate dehydrogenase inhibitor (SDHI) optionally Pyraziflumid of formula (I) 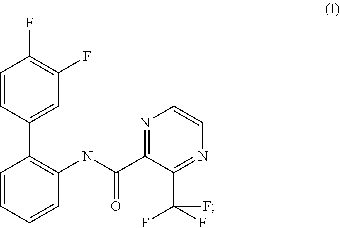 [SMILES: O=C(Nc1ccccc1-c1ccc(F)c(F)c1)c1nccnc1C(F)(F)F]
a compound of formula (II) 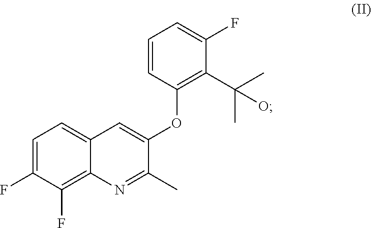
Quinofumelin of formula (III); 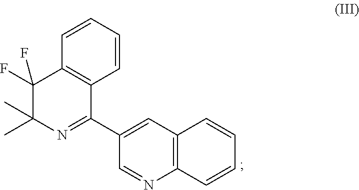 [SMILES: CC1(C)N=C(c2cnc3ccccc3c2)c2ccccc2C1(F)F]
a host plant defence inducer (HPDI) optionally Isotianil of formula (IV) 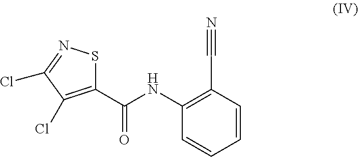 [SMILES: N#Cc1ccccc1NC(=O)c1snc(Cl)c1Cl]
or a HPDI compound of formula (V) 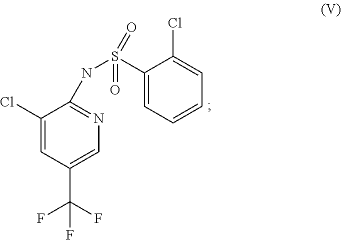 [SMILES: O=S(=O)(Nc1ncc(C(F)(F)F)cc1Cl)c1ccccc1Cl]
or
a C14-Demethylase Inhibitor (DMI) preferably Fluquinconazole of formula (VI) 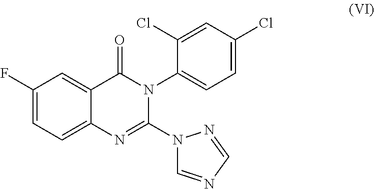 [SMILES: O=c1c2cc(F)ccc2nc(-n2cncn2)n1-c1ccc(Cl)cc1Cl]
or
Mefentrifluconazole of formula (VII) 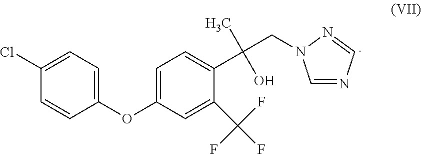 [SMILES: CC(O)(Cn1cncn1)c1ccc(Oc2ccc(Cl)cc2)cc1C(F)(F)F]
as a seed treatment for control of Sclerotinia spp.

2. Method according to claim 1, where the Sclerotinia species is Sclerotinia sclerotiorum.

3. Method according to claim 1, wherein seeds of plants are treated with Pyraziflumid.

4. Method according to claim 1, wherein seeds of plants are treated with a compound of formula (II).

5. Method according to claim 1, wherein seeds of plants are treated with Quinofumelin.

6. Method according to claim 1, wherein seeds of plants are treated with Isotianil.

7. Method according to claim 1, wherein seeds of plants are treated with a HPDI compound of formula (V).

8. Method according to claim 1, wherein seeds of plants are treated with Fluquinconazole.

9. Method according to claim 1, wherein seeds of plants are treated with Mefentrifluconazole.

10. Method according to claim 1, wherein the seeds of plants are selected from the group consisting of oilseed rape seed, sunflower seed, broad bean seed, pea seed and soybean seed, optionally soybean seed.

11. Method according to claim 1, wherein the plants are transgenic plants.

12. Method according to claim 1, wherein said active ingredient is employed in combination with a further active fungicidal or insecticidal ingredient.

13. A product capable of being used in a method of claim 1, said product comprising said active ingredient.
